(19) United States
(12) Patent Application Publication
(10) Pub. No.: US 2026/0358870 A1
(43) Pub. Date: Nov. 12, 2026

(54) COOLING PAD FOR LAPTOP COMPUTER

(71) Applicant: Cheng Yu Huang, New Taipei (TW)

(72) Inventor: Cheng Yu Huang, New Taipei (TW)

(21) Appl. No.: 19/204,881

(22) Filed: May 12, 2025

(51) Int. Cl. G06F 1/20

(52) U.S. Cl. CPC G06F 1/203

(57) ABSTRACT

A laptop cooling pad is provided with a casing; two pivotal members; two fastening members; an air guide board; a fan; a PCB; a flexible sealing pad; an LED light guide bar; and a removable filter assembly. The casing includes a base having an opening and two pivotal legs; and a cover having a recess on a top and through holes through the recess and communicating with the opening. The pivotal members are disposed at two sides of a rear portion of the recess respectively. The fastening members are disposed at two sides of a front portion of the recess respectively. The air guide board is disposed in the base. The fan is disposed above the opening. The sealing pad is disposed on the recess. The LED light guide bar is secured to a front end of the casing and electrically connected to the PCB.

### FIELD OF THE INVENTION

The invention relates to external cooling devices for computer and more particularly to a cooling pad for a laptop computer having improved characteristics.

### BACKGROUND OF THE INVENTION

Computer, communication, and consumer electronics (3C) are popular throughout the world in which laptop computers are characterized by lightweight, portability, multifunction, productivity, and a long period time of use.

However, the laptop computers are poor in heat dissipation ability due to its compactness and limited space.

Usually, if a laptop computer is used for a short period of time, its heat dissipation is not a problem. However, if it is used for a long time, it is more likely to overheat. Overheating may cause damage to the hard drive or the main board, and even cause damage to the computer itself. Users are at risk, especially when popular esports or video game programs are executed very quickly. Because of their fast operating speed, heat accumulation and temperature rise are more obvious, so that they are suitable for use in esports and video games. Laptop computers dedicated to video games usually require a larger screen size and many air vents at the bottom. Therefore, laptop computers dedicated to video games with larger screens and improved heat dissipation capabilities should be developed accordingly.

To the contrary, smaller laptop computers, in addition to smaller screens, usually do not have air vents at the bottom and a cooling fan next to the air vents. Instead, they use the internal wind to blow through the gap between the screen and the main board to expel gas and excessive heat.

Thus, the heat dissipation requirements for gaming-specific laptop computers are obviously higher than those for general laptop computers. In other words, the cooling pad suitable for this gaming-specific laptop computer adopts a high-speed and high-air volume turbine fan. The upper edge of the groove is in close contact with the bottom of the gaming laptop computer. The turbine fan in the groove of the cooling pad blows strong air to the bottom of the gaming laptop computer and allows the air to flow through the air vents at the bottom. The cooling air flows into the laptop computer for heat dissipation. However, if it is used for a smaller laptop computer, not only it will not make close contact, but also the air will not have a larger flow because there are no air vents at the bottom to vent and dissipate heat. The large air volume generated by the turbo fan will cause great noise and cause the laptop computer to vibrate greatly.

Thus, the need for improvement still exists.

### SUMMARY OF THE INVENTION

It is therefore one object of the invention to provide a cooling pad for a laptop computer comprising a casing; two pivotal members; two fastening members; a air guide board; a fan; a PCB; a flexible sealing pad; an LED light guide bar; and a removable filter assembly; wherein the casing includes a base having an opening and two rear pivotal legs; and a cover having a recess on a top and a plurality of through holes disposed through the recess and communicating with the opening; the pivotal members are disposed at two sides of a rear portion of the recess respectively; the fastening members are disposed at two sides of a front portion of the recess respectively; the air guide board, the fan, and the PCB are disposed in the casing; the air guide board is disposed in the base; the fan is disposed on the air guide board directly above the opening; the PCB is disposed in the casing; the flexible sealing pad is disposed on the recess and includes a hollow; the LED light guide bar is secured to a front end of the casing and electrically connected to the PCB, the LED light guide bar being configured to emit light of red, green, and blue (RGB) primary colors; and the removable filter assembly includes a dust cover, a filter, and a pressing board.

The above and other objects, features and advantages of the invention will become apparent from the following detailed description taken with the accompanying drawings

### BRIEF DESCRIPTION OF THE DRAWINGS

FIG. 1 is a perspective view of a cooling pad according to the invention, viewing from the top;

FIG. 2 is another perspective view of the cooling pad, viewing from the bottom and the filter assembly removed;

FIG. 3 is an exploded view of the cooling pad;

FIG. 4 is a perspective view of the fastening member;

FIG. 5 is a sectional view taken along line 5-5 of FIG. 4;

FIG. 6 is an exploded view of the fastening member;

FIG. 7 is a perspective view of the louver;

FIG. 8 is an exploded perspective view of the PCB;

FIG. 9 is a perspective view of a laptop computer placed on the cooling pad, viewing from the front, the laptop computer being for video game;

FIG. 10 is a longitudinal sectional view of FIG. 9;

FIG. 11 is a view similar to FIG. 9 with the pivotal member being pivoted upward to support an ordinary laptop computer; and

FIG. 12 is a longitudinal sectional view of FIG. 11.

### DETAILED DESCRIPTION OF THE INVENTION

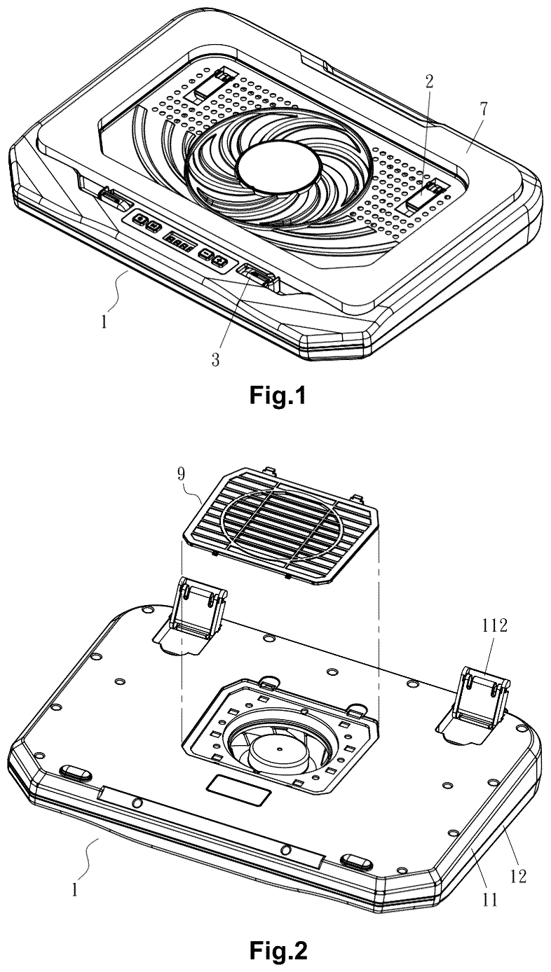

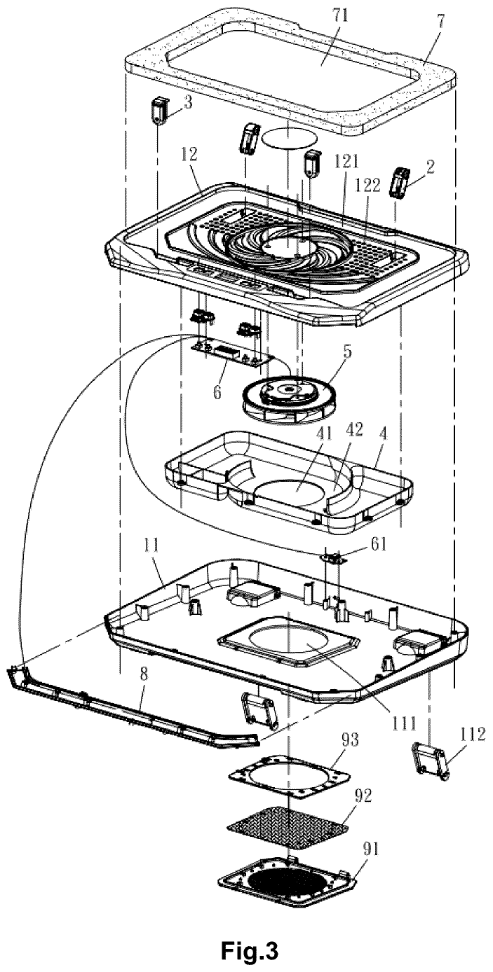

Referring to FIGS. 1 to 10, a cooling pad for a laptop computer G for video game in accordance with the invention comprises a casing 1, two pivotal members 2, two fastening members 3, a air guide board 4, a fan 5, a printed circuit board (PCB) 6, a flexible sealing pad 7, a light-emitting diode (LED) light guide bar 8, and a removable filter assembly 9 as discussed in detail below.

The casing 1 includes a base 11 and a cover 12. The base 11 include a central opening 111 and two rear pivotal legs 112.

The cover 12 includes a recess 121 on a top and a plurality of through holes 122 disposed through the recess 121 and communicating with the opening 111. The pivotal members 2 are disposed at two sides of a rear portion of the recess 121 respectively.

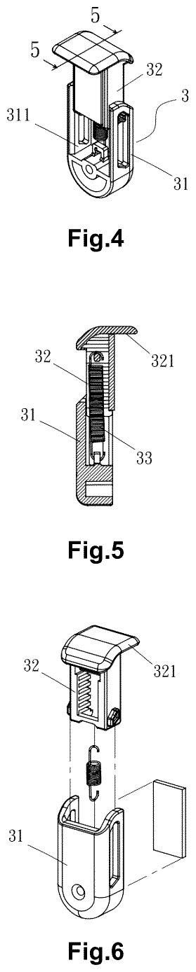

As shown in FIGS. 4-6 specifically, the fastening members 3 are disposed at two sides of a front portion of the recess 121 respectively. The fastening member 3 includes a support member 31 having an internal groove 311, a slide member 32 disposed in both the internal groove 311 and the support member 31 and having a snapping element 321 on a top, and a torsion spring 33 anchored between the support member 31 and the slide member 32. Thus, the slide member 32 may move upward or downward. The snapping elements 321 may fasten the laptop computer G when in use.

The air guide board 4, the fan 5, and the PCB 6 are disposed in the casing 1.

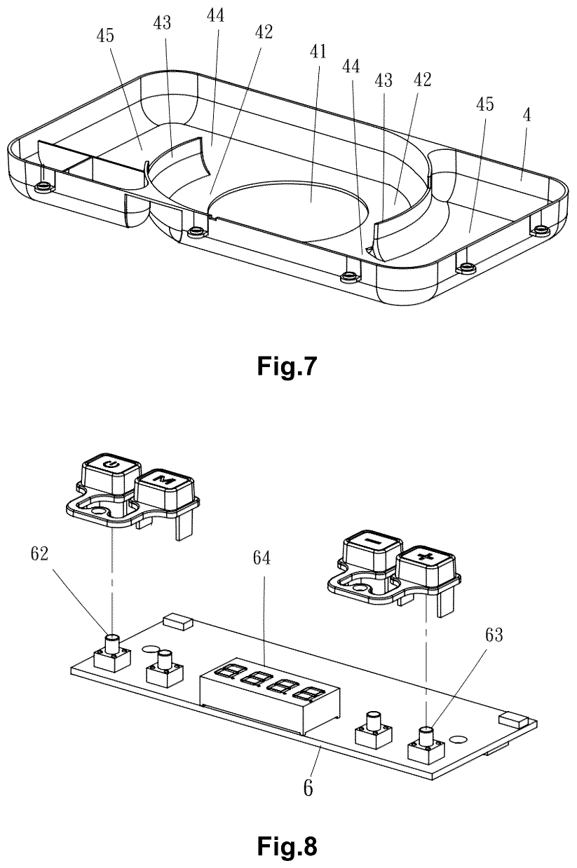

As shown in FIG. 7 specifically, the air guide board 4 is disposed in the base 11 and includes two spaces 45 at two sides respectively, a central cavity 42, an opening 41 through the cavity 42 and aligned with the central opening 111, two curved walls 43 at two sides of the cavity 42 respectively, and two channels 44 each disposed between the space 45 and the cavity 42 and communicating with them. Thus, the guided air will flow from the spaces 45 to the through holes 122 without being interrupted.

The fan 5 is disposed on the opening 41 directly above the central opening 111.

As shown in FIG. 8 specifically, the PCB 6 is disposed in the casing 1 and includes a C-shaped connector 61 electrically connected to a power supply (not shown), a plurality of control switches 62, a plurality of speed adjustment switches 63, and a speed indicator 64 all being disposed on a surface of the casing 1. The PCB 6 is electrically connected to the fan 5 so that the fan 5 may be activated and the rotation speed of the fan 5 is shown on the speed indicator 64.

The flexible sealing pad 7 is disposed on the recess 121 of the cover 12 and includes a hollow 71. The LED light guide bar 8 is secured to a front end of the casing 1 and electrically connected to the PCB 6. The LED light guide bar 8 may emit light of red, green, and blue (RGB) primary colors. The filter assembly 9 includes a dust cover 91, a filter 92, and a pressing board 93. A user may remove the filter assembly 9 for cleaning when a sufficient amount of dust is accumulated thereon.

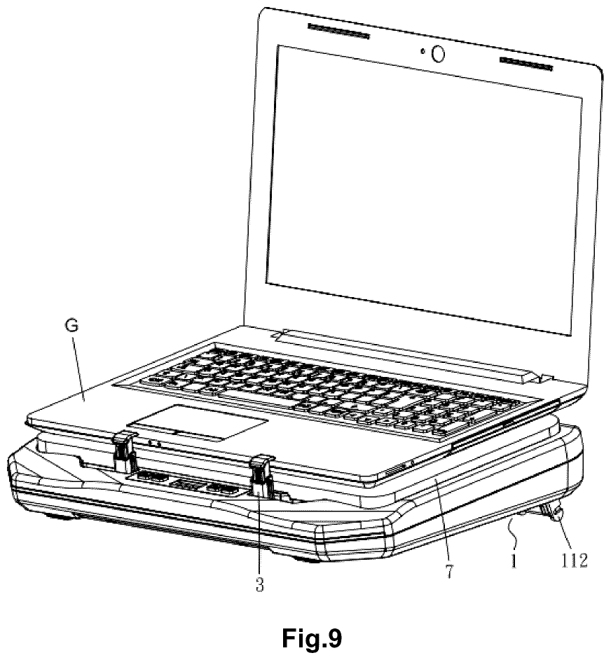

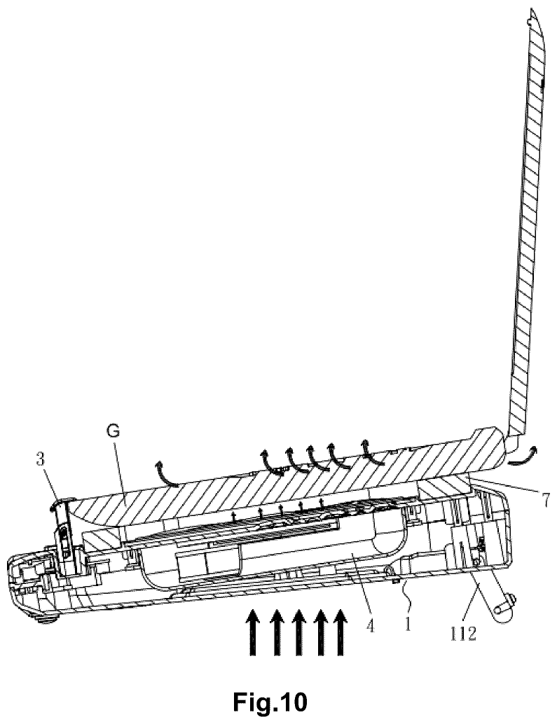

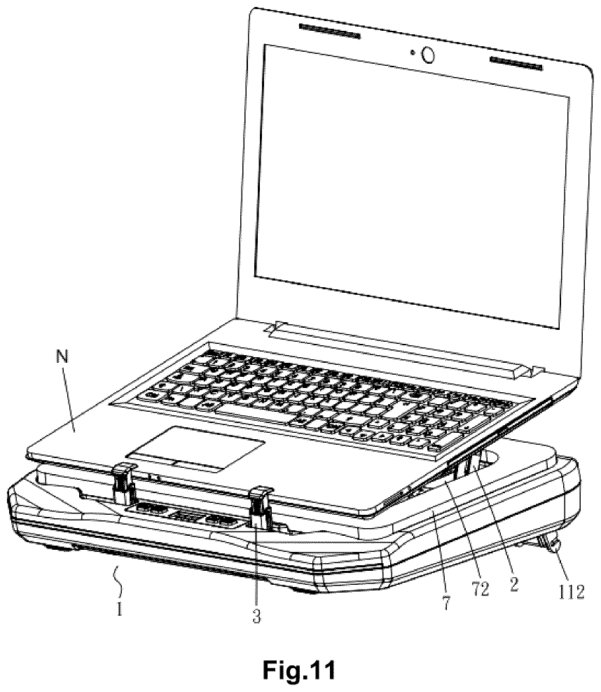

As shown in FIGS. 9 and 10 specifically, use of the cooling pad of the invention for the laptop computer G for video game is illustrated. The laptop computer G is placed on the casing 1. A user may pull the fastening members 3 upward and press the snapping elements 321 to fasten a front end of the laptop computer G. Also, the flexible sealing pad 7 is fully engaged with a bottom of the laptop computer G. The user may activate the fan 5 to produce a flow of air which is drawn through the air guide board 4. Finally, the air flows into the laptop computer G to take heat away from the laptop computer G.

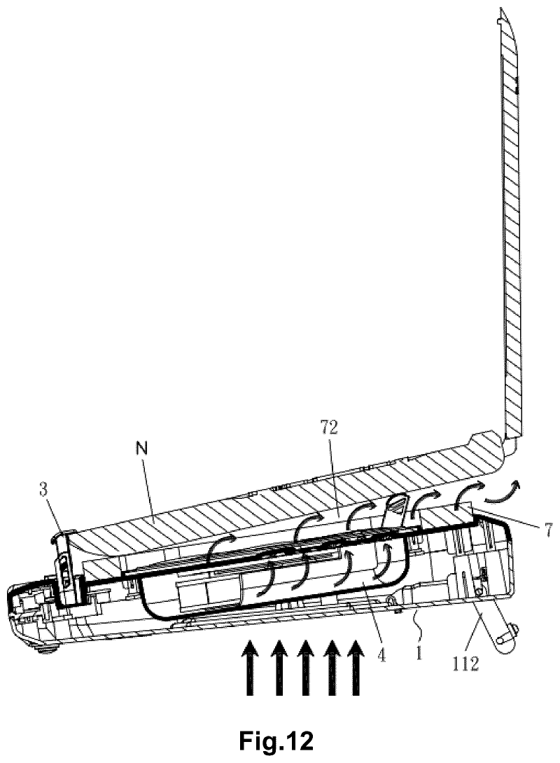

As shown in FIGS. 11 and 12 specifically, use of the cooling pad of the invention for an ordinary laptop computer N is illustrated. The laptop computer N is placed on the casing 1. The user may pull the fastening members 3 upward and press the snapping elements 321 to fasten a front end of the laptop computer N. Also, a gap 72 is formed between the flexible sealing pad 7 and a bottom of the laptop computer N. The user may activate the fan 5 to produce a flow of air. Most of the flow air is drawn through the air guide board 4 and a small amount of the flow air is drawn through the gap 72. Finally, the air flows into the laptop computer N to take heat away from the laptop computer N. Further, this can reduce generated noise and prevent the laptop computer N from being vibrated.

While the invention has been described in terms of embodiments, those skilled in the art will recognize that the invention can be practiced with modifications within the spirit and scope of the appended claim.

What is claimed is:

1. A cooling pad for a laptop computer, comprising:
a casing;
two pivotal members;
two fastening members;
a air guide board;
a fan;
a printed circuit board (PCB);
a flexible sealing pad;
a light-emitting diode (LED) light guide bar; and
a removable filter assembly;
wherein the casing includes a base having an opening and two rear pivotal legs;
and a cover having a recess on a top and a plurality of through holes disposed through the recess and communicating with the opening;
the pivotal members are disposed at two sides of a rear portion of the recess respectively;
the fastening members are disposed at two sides of a front portion of the recess respectively;
the air guide board, the fan, and the PCB are disposed in the casing;
the air guide board is disposed in the base;
the fan is disposed on the air guide board directly above the opening;
the PCB is disposed in the casing;
the flexible sealing pad is disposed on the recess and includes a hollow;
the LED light guide bar is secured to a front end of the casing and electrically connected to the PCB, the LED light guide bar being configured to emit light of red, green, and blue (RGB) primary colors; and
the removable filter assembly includes a dust cover, a filter, and a pressing board.

2. The cooling pad of claim 1, wherein each of the fastening members include a support member having an internal groove, a slide member disposed in both the internal groove and the support member, the slide member having a snapping element on a top, and a biasing member anchored between the support member and the slide member; and wherein the slide member is configured to move upward or downward.

3. The cooling pad of claim 1, wherein the air guide board includes two spaces at two sides respectively, a central cavity, an opening member through the central cavity, two curved walls at two sides of the cavity respectively, and two channels each disposed between one of the spaces and the central cavity and communicating with them; and wherein air is configured to flow from the spaces to the through holes.

4. The cooling pad of claim 1, wherein the PCB includes a C-shaped connector, a plurality of control switches, a plurality of speed adjustment switches, and a speed indicator all being disposed on a surface of the casing; wherein the PCB is electrically connected to the fan; and wherein a rotation speed of the fan is shown on the speed indicator.
